(19) United States
(12) Patent Application Publication
(10) Pub. No.: US 2024/0094340 A1
(43) Pub. Date: Mar. 21, 2024

(54) CALIBRATION DEVICE AND CALIBRATION METHOD FOR A TEST SYSTEM

(71) Applicant: Robert Bosch GmbH, Stuttgart (DE)

(72) Inventor: Yikun Yu, Reutlingen (DE)

(21) Appl. No.: 18/466,196

(22) Filed: Sep. 13, 2023

(30) Foreign Application Priority Data
Sep. 16, 2022 (DE) 10 2022 209 718.1

(51) Int. Cl. G01S 7/40

(52) U.S. Cl. CPC G01S 7/40

(57) ABSTRACT

A calibration device and method for a test system. First and second oscillators are actuated in such a way that a first signal which varies with a specified target frequency and a second signal which varies in phase with the first signal are output. A phase rotation device is actuated taking into account a target phase shift angle of 90° between the phase-shifted first signal and the second signal or between the phase-shifted first signal and the phase-shifted second signal such that an actual phase shift angle is produced. The phase-shifted first signal is mixed using a signal mixing device with the second signal or phase-shifted second signal to form an output signal. Deviation information is ascertained relating to a deviation of the actual phase shift angle from the target phase shift angle, taking into account the output signal.

### FIELD

The present invention relates to a calibration device for a test system and a test system for at least two oscillators. The present invention further relates to an oscillator system. The present invention also relates to a calibration method for a test system and a test method for at least two oscillators.

### BACKGROUND INFORMATION

FIGS. 1A and 1B show schematic overall and partial views of a conventional sensor which is applicant's internal prior art.

The conventional sensor 10 shown schematically in FIG. 1A comprises a plurality of chips 12 which are configured to transmit and receive radar signals. Each of the chips 12 includes a plurality of antennas 14, transmitting devices 16, receiving devices 18, analog-to-digital converters 20, a DSP unit (digital signal processing unit) 22 and a respective oscillator 24. As shown schematically in FIG. 1B, the respective oscillator 24 can be actuated by means of a control signal 26 with a reference frequency f_{REF} to output an oscillator signal 28 with a typically significantly lower target frequency f_{LO}, by means of which the transmitting devices 16 and receiving devices 18 of the respective chip 12 can be operated. However, as can be seen from the frequency distribution with a frequency f as the abscissa and an associated intensity I as the ordinate in FIG. 1B, the oscillator signal 28 often has interference frequencies 30, for example at a frequency f_{LO}−Δf and a frequency f_{LO}+Δf. This is often also referred to as interference frequencies 30 with a frequency offset of Δf.

### SUMMARY

The present invention provides a calibration device for a test system, a test system for at least two oscillators, an oscillator system, a calibration method for a test system, and a test method for at least two oscillators.

The present invention provides advantageous possibilities for realizing a test device, which, due to its advantageous calibration, can be used for reliably testing at least two oscillators, in particular for the occurrence of interference frequencies on the signals generated by the at least two oscillators. The present invention also contributes to reducing a test cycle time required to test the at least two oscillators. The use of the present invention moreover eliminates a conventional need to use external test components to test the at least two oscillators, as a result of which the costs for testing the at least two oscillators during production and/or during operation can be reduced. The present invention is in particular compatible with a cost-efficient and space-saving configuration of the test system using it, which is why a test system according to the present invention can be integrated as a BIST device (built-in-self-test device) into an oscillator system equipped with the at least two oscillators. The respective oscillator system can thus test its at least two oscillators itself, in particular with a specified self-test frequency, as a result of which its safety and reliability can be increased.

The at least two oscillators for which the present invention can be used can be understood to be a respective phase-locked loop comprising a controlled oscillator (PLL), for example. It is expressly noted that the present invention can also be used for testing at least two oscillators which are integrated on/into different chips. Use of the present invention is furthermore not limited to any specific use of the at least two oscillators.

According to an example embodiment of the present invention, the phase rotation device can preferably be actuated by means of the calibration device taking into account the deviation information before and/or during a test mode of the test system such that the deviation of the actual phase shift angle from the target phase shift angle is minimal during the test mode. The test system can then carry out its test function more accurately and more reliably during the test mode.

In one advantageous embodiment of the calibration device of the present invention, the deviation information can be ascertained by means of the calibration device on the basis of the further output signal which has been filtered out of the output signal using at least one filter device of the test system. A comparatively cost-efficient component of the test system, such as specifically at least one low-pass filter, can be used as the at least one filter device to generate the further output signal.

According to an example embodiment of the present invention, the deviation information can alternatively be ascertained by means of the calibration device on the basis of the further output signal generated from the output signal using the at least one spectrum analysis device of the test system via at least one analog-to-digital conversion and a Fourier transformation. Such a further output signal is also advantageously suitable for ascertaining the deviation information relating to the deviation of the actual phase shift angle from the target phase shift angle of 90°.

According to an example embodiment of the present invention, a test system for at least two oscillators comprising such a calibration device, the phase rotation device which can be actuated by means of the calibration device and the signal mixing device disposed downstream of the phase rotation device also realizes the above-described advantages.

As an advantageous further development of the present invention, the test system can comprise control and evaluation electronics, by means of which, during the test mode of the test system, interference frequency information relating to at least one interference frequency of the at least one first signal of the at least one first oscillator which varies with at least the specified target frequency and/or the at least one second signal of the at least one second oscillator which varies with at least the specified target frequency in phase with the at least one first signal can be ascertained taking into account the output signal or an evaluation signal derived from the output signal using the at least one and/or at least one further filter and/or spectrum analysis device of the test system. The thus ascertained interference frequency information can be used for a lower interference frequency operation of the at least one first oscillator and/or the at least one second oscillator such that a functioning of an oscillator system configured with the oscillators is improved.

According to an example embodiment of the present invention, the calibration device can in particular be integrated into the control and evaluation electronics of the test system. This can be used to miniaturize the test system, making it easier to use/assemble as a BIST device.

According to an example embodiment of the present invention, the above-described advantages may also be ensured with an oscillator system comprising a corresponding test system, the at least one first oscillator which can be actuated by means of the calibration device of the test system and the at least one second oscillator which can be actuated by means of the calibration device.

According to an example embodiment of the present invention, the oscillator system can be a transmitting and receiving system or a radar sensor system, for instance. Due to the advantageous suppression/avoidance of interference frequencies in the signals generated by the oscillators of the oscillator system made possible by the test system, the transmitting and receiving system or radar sensor system has a lower noise level and/or a higher sensitivity.

Carrying out a corresponding calibration method for a test system according to the present invention likewise enables the above-described advantages. The calibration method can be further developed according to the embodiments of the calibration device.

Carrying out a corresponding test method for at least two oscillators moreover produces the abovementioned advantages as well. The test method can be further developed according to the embodiments of the test system.

### BRIEF DESCRIPTION OF THE DRAWINGS

Further features and advantages of the present invention are explained in the following with reference to the figures.

FIGS. 1A and 1B show schematic overall and partial views of a conventional sensor.

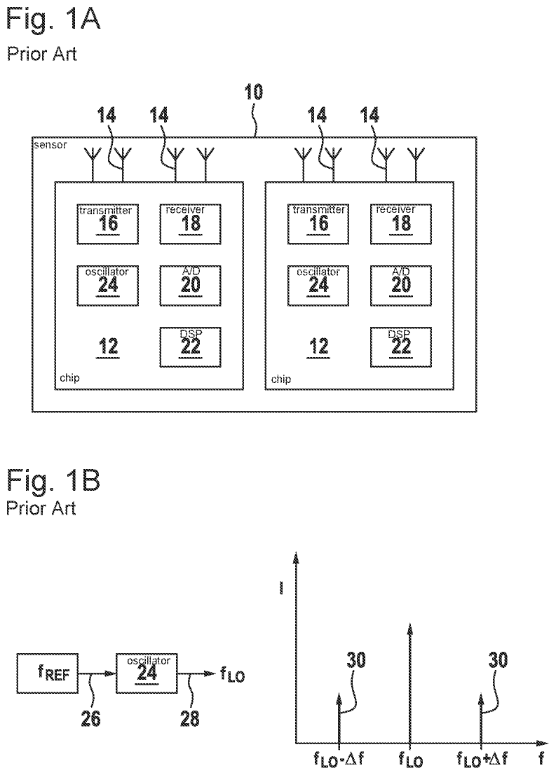

FIG. 2 shows a schematic illustration of a first embodiment of the test system according to an example embodiment of the present invention to explain a mode of operation of its calibration device.

FIG. 3 shows a schematic illustration of a second embodiment of the test system according to an example embodiment of the present invention to explain a mode of operation of its calibration device

FIG. 4 shows a flow chart to explain an embodiment of the calibration method for a test system, according to an example embodiment of the present invention.

### DETAILED DESCRIPTION OF EXAMPLE EMBODIMENTS

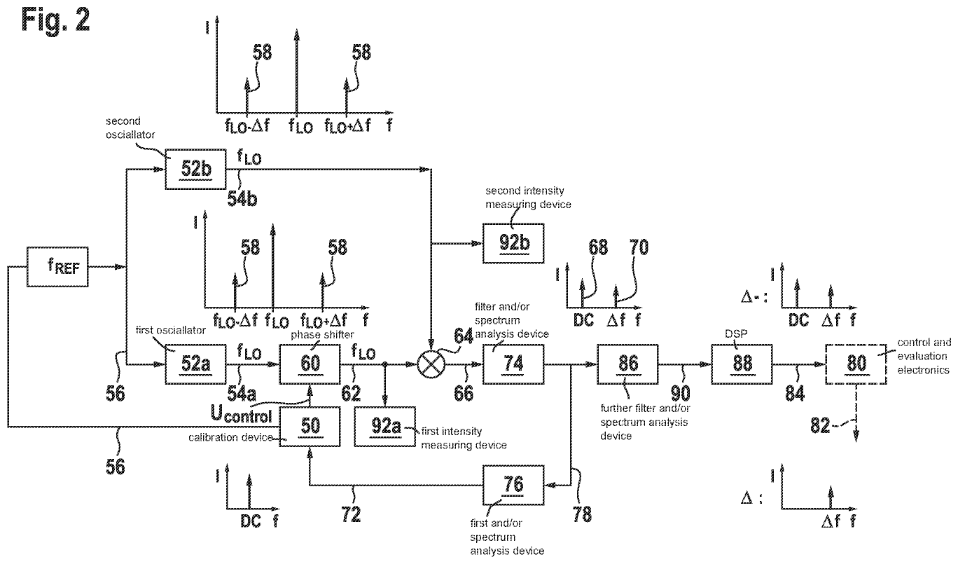

FIG. 2 shows a schematic illustration of a first embodiment of the test system to explain a mode of operation of its calibration device. All of the frequency distributions shown in FIG. 2 indicate a frequency f by means of their abscissa and an associated intensity I by means of their ordinate.

The calibration device 50 shown schematically in FIG. 2 is configured/programmed to actuate at least one first oscillator 52a and at least one second oscillator 52b in such a way that at least one first signal 54a is/can be output by means of the at least one first oscillator 52a and at least one second signal 54b is/can be output by means of the at least one second oscillator 52b. The oscillators 52a and 52b which can be/are actuated by the calibration device 50 can be test system-internal and/or test system-external oscillators 52a and 52b. The at least two oscillators 52a and 52b can be understood to be a respective phase-locked loop comprising a controlled oscillator (PLL), for instance. The oscillators 52a and 52b can be configured in SiGe technology and/or in CMOS technology. for example. Although not shown in FIG. 2, the oscillators 52a and 52b can be configured on/in different chips. The calibration device 50, or the test system equipped with the calibration device, can therefore also advantageously be used to optimize a cooperation of a plurality of the oscillators 52a and 52b integrated on/in different chips in the manner described in the following.

The calibration device 50 can, for instance, be configured/programmed to output a control signal 56 having a reference frequency f_{REF} simultaneously to both the at least one first oscillator 52a and the at least one second oscillator 52b. The at least one first signal 54a output by the at least one first oscillator 52a in response to the control signal 56 varies with at least one specified target frequency f_{LO}, which is typically significantly lower than the reference frequency f_{REF}. Accordingly, at least one second signal 54b which varies with at least the specified target frequency f_{LO} in phase with the at least one first signal 54a can be/is output by means of the at least one second oscillator 52b. As an alternative to the single control signal 56, a plurality of (not depicted) control signals having different reference frequencies f_{REF} can also be output to the oscillators 52a and 52b. In this case, however, the oscillators 52a and 52b are additionally actuated in such a way that their signals 54a and 54b have the same target frequency f_{LO} and are in phase with one another.

However, as can be seen in FIG. 2 on the basis of a respective frequency distribution of the signals 54a and 54b, the at least one first signal 54a and/or the at least one second signal 54b can also vary with at least one interference frequency 58, such as with a first interference frequency f_{LO}−Δf and/or with a second interference frequency f_{LO}+Δf. The interference frequencies 58 can thus occur in at least the first signal 54a and/or in at least the second signal 54b with a frequency offset of Δf.

The test system also comprises a phase rotation device (phase shifter) 60, which can be actuated by means of the calibration device 50. The calibration device 50 is in particular configured/programmed to actuate the phase rotation device 60 at least taking into account a (desired) target phase shift angle of 90° between at least one first signal 62 which has been phase-shifted by means of the phase rotation device 60 and the at least one second signal 54b or between the at least one phase-shifted first signal 62 and at least one (not shown) second signal which has been phase-shifted by means of the phase rotation device 60. Thus, an actual phase shift angle is produced between the at least one phase-shifted first signal 62 and the at least one second signal 54b/phase-shifted second signal by means of the phase rotation device 60. The phase rotation device 60 is actuated by means of the calibration device 50 in such a way that an actual phase shift angle between the at least one phase-shifted first signal 62 and the at least one second signal 54b/phase-shifted second signal of nearly 90° can be expected with a high probability. The phase rotation device 60 can be actuated by means of the calibration device 50 by varying a control voltage U_{control} of the phase rotation device 60, for instance.

A signal mixing device (frequency mixer/mixer) 64 of the test system, to which the at least one phase-shifted first signal 62 and the at least one second signal 54b/phase-shifted second signal are provided, is disposed downstream of the phase rotation device 60. The at least one phase-shifted first signal 62 and the at least one second signal 54b/phase-shifted second signal can be/are mixed by means of the signal mixing device 64 to form an output signal 66. Based on the frequency distribution of the output signal 66, it can be seen that the output signal 66 varies at least with a frequency f_{DC}, wherein an intensity I(f_{DC}) of the peak 68 at the frequency f_{DC} is dependent on a deviation of the actual phase shift angle from the target phase shift angle of 90°. The frequency f_{DC} can in particular be equal to twice the target frequency f_{LO}. At least one interference frequency peak 70 which can be attributed to the at least one interference frequency 58 can additionally occur in the frequency distribution of the output signal 66 at a frequency f_{Δf}.

Deviation information relating to the deviation of the actual phase shift angle from the target phase shift angle of 90° can therefore be ascertained by means of the calibration device 50 on the basis of the output signal 66 or a further output signal 72 derived from the output signal 66. The deviation information can advantageously be used to check to what extent the cooperation of the phase rotation device 60 and the signal mixing device 64 “offsets” frequency components in the output signal 66 that can be attributed to the target frequency f_{LO} of the first signal 54a and the target frequency f_{LO} of the second signal 54b, so that the at least one interference frequency 58 of the at least one first signal 54a and/or the at least one second signal 54b can be detected more easily and more reliably.

The further output signal 72, which can be evaluated to ascertain the deviation information, can be derived from the output signal 66 using at least one filter and/or spectrum analysis device 74 and 76 of the test system, as explained in more detail below.

The phase rotation device 60 can then be actuated by means of the calibration device 50 taking into account the deviation information before and/or during a test mode Δ of the test system cooperating with it such that the deviation of the actual phase shift angle from the target phase shift angle of 90° is minimal during the test mode Δ of the test system. The calibration device 50 thus brings about a test mode Δ of the test system, during which the at least one interference frequency 58 of the at least one first signal 54a and/or the at least one second signal 54b can be detected more accurately and more reliably.

In the test system of FIG. 2, the output signal 66 is output to at least one filter device 74 and 76 of the test system, so that the further output signal 72 is filtered out of the output signal 66 with respect to the frequency f_{DC} by means of the at least one filter device 74 and 76. For this reason, the calibration device 50 which cooperates with the test system of FIG. 2 is configured/programmed such that the deviation information can be/is ascertained by means of the calibration device 50 on the basis of the further output signal 72 which is filtered out using the at least one filter device 74 and 76. As an example, the test system comprises a first low-pass filter 74 as the first filter device 74, the first passband of which includes a frequency range between the frequency f_{DC} and frequency offset Δf. An intermediate signal 78 is filtered out of the output signal 66 by means of the first low-pass filter 74. The intermediate signal 78 is output to a second low-pass filter 76 as the second filter device 78, by means of which the further output signal 72 is filtered out of the intermediate signal 78. A second passband of the second low-pass filter 76 is at the frequency f_{DC}.

The calibration device 50 is configured/programmed to ascertain the deviation information until an actuation of the phase rotation device 60 is effected, at which the deviation of the actual phase shift angle from the target phase shift angle of 90° is minimal. The minimum deviation can in particular be understood to be a deviation equal to zero of the actual phase shift angle from the target phase shift angle of 90°. During the test mode Δ of the test system, the calibration device 50 continues to actuate the phase rotation device 60 such that the minimum deviation of the actual phase shift angle from the target phase shift angle of 90° is/remains maintained.

During the test mode Δ, an examination of the signals 54a and 54b of the oscillators 52a and 52b can be carried out by means of (optional) control and evaluation electronics 80 of the test system. During the test mode Δ, the control and evaluation electronics 80 are preferably configured/programmed to ascertain interference frequency information 82 relating to the at least one interference frequency 58 of the at least one first signal 54a and/or the at least one second signal 54b. The target frequency f_{LO} can optionally be varied during the test mode Δ, which enables the ascertainment of interference frequency information 82 that is dependent on the target frequency f_{LO}. The ascertainment of interference frequency information 82 can advantageously be carried out by means of control and evaluation electronics 80 taking into account the output signal 66 or an evaluation signal 84 derived from the output signal 66. Since the peak 68 at the frequency f_{DC} is (nearly) completely compensated out of the output signal 66 when the deviation of the actual phase shift angle from the target phase shift angle of 90° is minimum, the at least one interference frequency peak 70 in the output signal 66 or in the evaluation signal 84 can be detected more reliably. The evaluation of the output signal 66 or the evaluation signal 84 thus enables a more accurate and more reliable determination of the at least one interference frequency 58 of the at least one first signal 54a and/or the at least one second signal 54b when the deviation of the actual phase shift angle from the target phase shift angle of 90° is minimum.

The evaluation signal 84 which is evaluated to ascertain the interference frequency information 82 can be/is in particular derived from the output signal 66 using the at least one and/or at least one further filter and/or spectrum analysis device 86 and/or 88 of the test system. In the embodiment of FIG. 2, the intermediate signal 78 generated by means of the first low-pass filter 74 is provided to an analog-to-digital converter (ADC) 86 during the test mode Δ of the test system. A digital signal 90 generated by the analog-to-digital converter 86 is then converted into the evaluation signal 84 by a processing device (digital signal processing unit) 88 by executing a Fourier transformation, in particular a fast Fourier transformation (FFT). Instead of the analog-to-digital converter 86 and the processing device 88, it is also possible to use a (not shown) spectrum analyzer, by means of which at least one analog-to-digital conversion and a Fourier transformation can be executed.

For comparison, FIG. 2 shows the frequency distributions of the evaluation signal 84 before the test mode Δ and during the test mode Δ. From the comparison of the frequency distributions of the evaluation signal 84, it can be seen that the at least one interference frequency 58 of the at least one first signal 54a and/or the at least one second signal 54b, or the phase shift Δf that occurs in at least the first signal 54a and/or at least the second signal 54b, can be ascertained more reliably and more accurately during the test mode Δ.

As an optional further development, the test system can also be equipped with a first intensity measuring device 92a for measuring a first signal intensity of the at least one first signal 54a and/or with a second intensity measuring device 92b for measuring a second signal intensity of the at least one second signal 54b. The at least one intensity measuring device 92a and 92b can be a respective diode or a self-mixing signal mixer (self-mixing mixer).

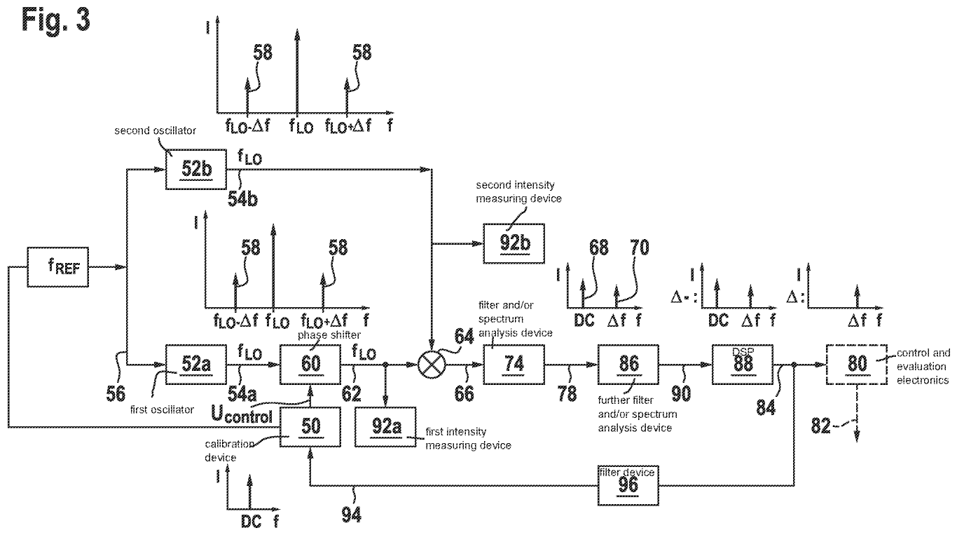

FIG. 3 shows a schematic illustration of a second embodiment of the test system to explain a mode of operation of its calibration device. All of the frequency distributions shown in FIG. 3 indicate a frequency f by means of their abscissa and an associated intensity I by means of their ordinate.

In the test system of FIG. 3, too, the deviation information is/can be ascertained by means of the calibration device 50 on the basis of a further output signal 94, which is generated from the output signal 66 by at least one analog-to-digital conversion and a Fourier transformation, in particular a fast Fourier transformation (FFT). For this purpose, the evaluation signal 84 obtained by means of the analog-to-digital converter 86 and the processing device 88 or by means of the spectrum analyzer is output to a filter device 96, through which the DC value, i.e. a value corresponding to the frequency f_{DC}, can pass. The further output signal 94 filtered by means of the filter device 96 can then be evaluated by means of calibration device 50.

With regard to further properties and features of the test system of FIG. 3/its calibration device 50 and their respective advantages, reference is made to the statements relating to the embodiment of FIG. 2.

In any of the above-described embodiments, the calibration device 50 can be a component/subunit of the test system. The calibration device 50 can in particular be integrated into the control and evaluation electronics 80 of the test system. Alternatively, however, the calibration device 50 can also cooperate with the test system as a device disposed externally to the test system.

The above-described test devices can each be part of an oscillator system, which additionally comprises the at least one first oscillator 52a which can be actuated by means of the calibration device 50 of the test system and the at least one second oscillator 52b which can be actuated by means of the calibration device 50. The oscillator system can be used as a transmitting and receiving system, for instance. Obtaining the interference frequency information 82, makes it possible to optimize the operation of the oscillators 52a and 52b such that a functioning of the oscillator system equipped with the oscillators 52a and 52b is improved. In an oscillator system being used as a transmitting and receiving system, for example, noise levels can be reduced and/or a reception sensitivity can be increased on the basis of interference frequency information 82. Although the oscillators 52a and 52b can also be configured on/in different chips, their functioning can advantageously be coordinated by means of calibration device 50.

The oscillator system can in particular be a radar sensor system. The radar sensor system equipped with the calibration device 50 has an increased signal transmission intensity, a lower noise level, a greater target detection range and a better angular resolution than the related art. The radar sensor system can be implemented on the basis of RF and/or millimeter waves, specifically as a 77 GHz radar, a 60 GHz wireless LAN or as a 5G cellular network. The radar sensor system can in particular be an AIR system (automotive imaging radar sensor).

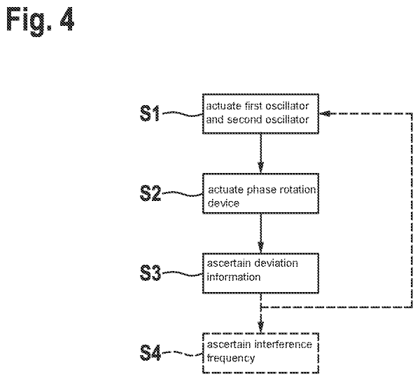

FIG. 4 shows a flow chart to explain an embodiment of the calibration method for a test system.

The calibration method described in the following can, for example, be carried out by means of any one of the test systems discussed above. However, a reproducibility of the calibration method is not limited to the test systems.

In a method step S1, at least one test system-internal or test system-external first oscillator and at least one test system-internal or test system-external second oscillator are actuated in such a way that at least one first signal which varies with at least one specified target frequency is output by means of the at least one first oscillator while at least one second signal which varies with at least the specified target frequency in phase with the at least one first signal is output by means of the at least one second oscillator. Embodiment examples for the at least two oscillators have already been listed above.

During the method step S1, a method step S2 is carried out as well. In method step S2, a phase rotation device of the test system is actuated at least taking into account a target phase shift angle of 90° between at least one first signal which has been phase-shifted by means of the phase rotation device and the at least one second signal or between the at least one phase-shifted first signal and at least one second signal which has been phase-shifted by means of the phase rotation device. Thus, an actual phase shift angle is produced between the at least one phase-shifted first signal and the at least one second signal or phase-shifted second signal. The at least one phase-shifted first signal is also mixed with the at least one second signal or phase-shifted second signal by means of a signal mixing device of the test system to form an output signal.

In a further method step S3, deviation information relating to a deviation of the actual phase shift angle from the target phase shift angle is ascertained. This is done taking into account the output signal or a further output signal derived from the output signal using at least one filter and/or spectrum analysis device of the test system. The deviation information is ascertained on the basis of the further output signal which has been filtered out of the output signal using at least one filter device of the test system, for example. The deviation information can alternatively also be ascertained on the basis of the further output signal generated from the output signal using the at least one spectrum analysis device of the test system via at least one analog-to-digital conversion and a Fourier transformation.

The method steps S1 to S3 can be repeated continuously, wherein the phase rotation device can be actuated taking into account the deviation information before and/or during a test mode of the test system such that the deviation of the actual phase shift angle from the target phase shift angle is minimal during the test mode. This results in an advantageous calibration of the test system for measurements and/or studies carried out during its test mode.

As an advantageous further development, the calibration method can therefore also be part of a test method for at least two oscillators. In this case, a phase rotation device of the respective test system is first calibrated to a target phase shift angle of 90° by carrying out method steps S1 to S3 at least once. Subsequently, in a (optional) method step S4 during the test mode of the test system, interference frequency information relating to at least one interference frequency of the at least one first signal of the at least one first oscillator which varies with at least the specified target frequency and/or at least one second signal of the at least one second oscillator which varies with at least the specified target frequency in phase with the at least one first signal is ascertained. The interference frequency information is ascertained taking into account the output signal or an evaluation signal derived from the output signal using the at least one and/or at least one further filter and/or spectrum analysis device of the test system.

1-14. (canceled)

15. A calibration device for a test system, configured to:
actuate at least one test system-internal or test system-external first oscillator and at least one test system-internal or test system-external second oscillator in such a way that at least one first signal which varies with at least one specified target frequency is output using the at least one first oscillator and at least one second signal which varies with at least the specified target frequency in phase with the at least one first signal of the at least one first oscillator is output using the at least one second oscillator;
actuate a phase rotation device of the test system taking into account a target phase shift angle of 90° between at least one first signal which has been phase-shifted using the phase rotation device and the at least one second signal of the at least one second oscillator or between the at least one phase-shifted first signal and at least one second signal which has been phase-shifted using the phase rotation device such that an actual phase shift angle is produced between the at least one phase-shifted first signal and the at least one second signal of the at least one second oscillator or the phase-shifted second signal, and the at least one phase-shifted first signal is mixed using a signal mixing device of the test system with the at least one second signal of the at least one second oscillator or the phase-shifted second signal to form an output signal; and
ascertain deviation information relating to a deviation of the actual phase shift angle from the target phase shift angle based on the output signal or a further output signal derived from the output signal, using at least one filter and/or spectrum analysis device of the test system.

16. The calibration device according to claim 15, wherein the phase rotation device is actuated using the calibration device taking into account the deviation information before and/or during a test mode of the test system such that the deviation of the actual phase shift angle from the target phase shift angle is minimal during the test mode.

17. The calibration device according to claim 15, wherein the deviation information is ascertained using the calibration device based on the further output signal which has been filtered out of the output signal using at least one filter device of the test system.

18. The calibration device according to claim 15, wherein the deviation information is ascertained using the calibration device based on the further output signal generated from the output signal using at least one spectrum analysis device of the test system via at least one analog-to-digital conversion and a Fourier transformation.

19. A test system for at least two oscillators, comprising:
a calibration device configured to:
actuate at least one test system-internal or test system-external first oscillator and at least one test system-internal or test system-external second oscillator in such a way that at least one first signal which varies with at least one specified target frequency is output using the at least one first oscillator and at least one second signal which varies with at least the specified target frequency in phase with the at least one first signal of the at least one first oscillator is output using the at least one second oscillator,
actuate a phase rotation device of the test system taking into account a target phase shift angle of 90° between at least one first signal which has been phase-shifted using the phase rotation device and the at least one second signal of the at least one second oscillator or between the at least one phase-shifted first signal and at least one second signal which has been phase-shifted using the phase rotation device such that an actual phase shift angle is produced between the at least one phase-shifted first signal and the at least one second signal of the at least one second oscillator or the phase-shifted second signal, and the at least one phase-shifted first signal is mixed using a signal mixing device of the test system with the at least one second signal of the at least one second oscillator or the phase-shifted second signal to form an output signal, and
ascertain deviation information relating to a deviation of the actual phase shift angle from the target phase shift angle based on the output signal or a further output signal derived from the output signal, using at least one filter and/or spectrum analysis device of the test system;
the phase rotation device actuatable using the calibration device; and
the signal mixing device disposed downstream of the phase rotation device.

20. The test system according to claim 19, further comprising:
control and evaluation electronics, using which, during the test mode of the test system, interference frequency information relating to at least one interference frequency of the at least one first signal of the at least one first oscillator which varies with at least the specified target frequency and/or the at least one second signal of the at least one second oscillator which varies with at least the specified target frequency in phase with the at least one first signal of the at least one first oscillator is ascertained taking into account the output signal or an evaluation signal derived from the output signal using the at least one filter and/or spectrum analysis device of the test system and/or at least one further filter and/or spectrum analysis device of the test system.

21. The test system according to claim 20, wherein the calibration device is integrated into the control and evaluation electronics of the test system.

22. An oscillator system, comprising:
a test system including:
a calibration device configured to:
actuate at least one test system-internal or test system-external first oscillator and at least one test system-internal or test system-external second oscillator in such a way that at least one first signal which varies with at least one specified target frequency is output using the at least one first oscillator and at least one second signal which varies with at least the specified target frequency in phase with the at least one first signal of the at least one first oscillator is output using the at least one second oscillator,
actuate a phase rotation device of the test system taking into account a target phase shift angle of 90° between at least one first signal which has been phase-shifted using the phase rotation device and the at least one second signal of the at least one second oscillator or between the at least one phase-shifted first signal and at least one second signal which has been phase-shifted using the phase rotation device such that an actual phase shift angle is produced between the at least one phase-shifted first signal and the at least one second signal of the at least one second oscillator or the phase-shifted second signal, and the at least one phase-shifted first signal is mixed using a signal mixing device of the test system with the at least one second signal of the at least one second oscillator or the phase-shifted second signal to form an output signal, and
ascertain deviation information relating to a deviation of the actual phase shift angle from the target phase shift angle based on the output signal or a further output signal derived from the output signal, using at least one filter and/or spectrum analysis device of the test system;
the phase rotation device actuatable using the calibration device; and
the signal mixing device disposed downstream of the phase rotation device;
the at least one first oscillator which is actuatable by the calibration device of the test system; and
the at least one second oscillator which is actuatable by the calibration device of the test system.

23. The oscillator system according to claim 22, wherein the oscillator system is a transmitting and receiving system or a radar sensor system.

24. A calibration method for a test system, comprising the following steps:
actuating at least one test system-internal or test system-external first oscillator and at least one test system-internal or test system-external second oscillator in such a way that at least one first signal which varies with at least one specified target frequency is output using the at least one first oscillator and at least one second signal which varies with at least the specified target frequency in phase with the at least one first signal of the at least one first oscillator is output using the at least one second oscillator;
actuating a phase rotation device of the test system at least taking into account a target phase shift angle of 90° between at least one first signal which has been phase-shifted using the phase rotation device and the at least one second signal of the at least one second oscillator or between the at least one phase-shifted first signal and at least one second signal which has been phase-shifted using the phase rotation device such that an actual phase shift angle is produced between the at least one phase-shifted first signal and the at least one second signal of the at least one second oscillator or the phase-shifted second signal, and the at least one phase-shifted first signal is mixed using a signal mixing device of the test system with the at least one second signal of the at least one second oscillator or the phase-shifted second signal to form an output signal; and
ascertaining deviation information relating to a deviation of the actual phase shift angle from the target phase shift angle, taking into account the output signal or a further output signal derived from the output signal using at least one filter and/or spectrum analysis device of the test system.

25. The calibration method according to claim 24, wherein the phase rotation device is actuated taking into account the deviation information before and/or during a test mode of the test system such that the deviation of the actual phase shift angle from the target phase shift angle is minimal during the test mode.

26. The calibration method according to claim 24, wherein the deviation information is ascertained based on the further output signal which has been filtered out of the output signal using at least one filter device of the test system.

27. The calibration method according to claim 24, wherein the deviation information is ascertained based on the further output signal generated from the output signal using the at least one spectrum analysis device of the test system via at least one analog-to-digital conversion and a Fourier transformation.

28. A test method for at least two oscillators, comprising the following steps:
calibrating a phase rotation device of a test system to a target phase shift angle of 90° by:
actuating at least one test system-internal or test system-external first oscillator and at least one test system-internal or test system-external second oscillator in such a way that at least one first signal which varies with at least one specified target frequency is output using the at least one first oscillator and at least one second signal which varies with at least the specified target frequency in phase with the at least one first signal of the at least one first oscillator is output using the at least one second oscillator,
actuating a phase rotation device of the test system at least taking into account the target phase shift angle of 90° between at least one first signal which has been phase-shifted using the phase rotation device and the at least one second signal of the at least one second oscillator or between the at least one phase-shifted first signal and at least one second signal which has been phase-shifted using the phase rotation device such that an actual phase shift angle is produced between the at least one phase-shifted first signal and the at least one second signal of the at least one second oscillator or the phase-shifted second signal, and the at least one phase-shifted first signal is mixed using a signal mixing device of the test system with the at least one second signal of the at least one second oscillator or the phase-shifted second signal to form an output signal, and
ascertaining deviation information relating to a deviation of the actual phase shift angle from the target phase shift angle, taking into account the output signal or a further output signal derived from the output signal using at least one filter and/or spectrum analysis device of the test system
ascertaining interference frequency information relating to at least one interference frequency of the at least one first signal of the at least one first oscillator which varies with at least the specified target frequency and/or the at least one second signal of the at least one second oscillator which varies with at least the specified target frequency in phase with the at least one first signal of the at least one first oscillator taking into account the output signal or an evaluation signal derived from the output signal using the at least one filter and/or spectrum analysis device of the test system and/or at least one further filter and/or spectrum analysis device of the test system, during the test mode of the test system.
